(19) United States
(12) Patent Application Publication
(10) Pub. No.: US 2025/0245244 A1
(43) Pub. Date: Jul. 31, 2025

(54) Framework Neutral and Updatable Clustering Model

(71) Applicant: ServiceNow, Inc., Santa Clara, CA (US)

(72) Inventors: Sriram Puttagunta, Hyderabad (IN); Jishnu Sethumadhavan Nair, Hyderabad (IN); Bidyapati Pradhan, Hyderabad (IN); Nirali Dineshbhai Popat, Hyderabad (IN); Sravan Ramachandran, Karnataka (IN); Vipul Mittal, Hyderabad (IN); Seganrasan Subramanian, Hyderabad (IN); Ranga Prasad Chenna, Hyderabad (IN)

(21) Appl. No.: 18/426,810

(22) Filed: Jan. 30, 2024

(51) Int. Cl. G06F 16/28

(52) U.S. Cl. CPC G06F 16/285

(57) ABSTRACT

An example embodiment may involve receiving a representation of a parameter of a first clustering model (such as the cluster centroid in a k-means clustering model) where the representation of the parameter is associated with training data in accordance with a first set of software libraries. Possibly based on the parameter, a second clustering model in accordance with a second set of software libraries could be generated. As a consequence, the second clustering model could make a prediction result based on a received prediction request.

### BACKGROUND

Clustering models, such as those produced using k-means clustering, can provide useful groupings of data, including clustering semantically similar text objects into a common group. However, one programming language can have properties that are better suited for training a clustering model (e.g., improved computational efficiency), whereas another programing language can have properties that are better suited for using a trained clustering model (e.g., improved compatibility with the other software within computing environments). Thus, selecting a common programing language for the training of and prediction with a clustering model may involve making a trade-off between computational efficiency and compatibility. Further, it is computationally expensive to retrain a clustering model too frequently.

### SUMMARY

Various implementations include separating the training and use of a clustering model into two computational environments. The first computational environment enables the training of a clustering model. The second computational environment enables the making of predictions using the trained clustering model. Each environment can potentially use different programming languages with respectively different software libraries.

To facilitate the sharing of a trained clustering model from the first computational environment to the second computational environment, the parameters of the trained clustering model can be represented as a set of artifacts. A potential advantage is that these parameters do not need to be all of those used for the training and evaluation of the clustering model. Instead, a subset of the artifacts that facilitate prediction using the trained clustering model can be provided to the second computational environment. Sending less than all artifacts between the environments reduces use of computational resources and network capacity, and decreases the time required for the transfer.

Further, once a clustering model is trained, the artifacts associated with the trained clustering model can be updated after receiving new training data, such as new text objects. Updating the artifacts rather than retraining the clustering model from the beginning decreases the time required to develop an updated clustering model.

Accordingly, a first example embodiment may involve receiving a representation of a parameter of a first clustering model, wherein each of the first clustering model and the representation of the parameter is associated with training data in accordance with a first set of software libraries. Based on the parameter, a second clustering model in accordance with a second set of software libraries maybe generated. Further, a prediction request may be provided to the second clustering model. Moreover, a prediction result based on the prediction request, may be generated by using the second clustering model.

A second example embodiment may involve a non-transitory computer-readable medium, having stored thereon program instructions that, upon execution by a computing system, cause the computing system to perform operations in accordance with the first example embodiment.

In a third example embodiment, a computing system may include one or more processors, as well as memory and program instructions. The program instructions may be stored in the memory, and upon execution by the at least one processor, cause the computing system to perform operations in accordance with the first example embodiment.

In a fourth example embodiment, a system may include various means for carrying out each of the operations of the first example embodiment. Such means could include one or more processors and memory, containing program instructions that, upon execution by the one or more processors, cause the system to perform operations.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts a clustering space, in accordance with example embodiments.

FIG. 7 depicts a training and prediction framework, in accordance with example embodiments.

FIG. 8 depicts an update framework, in accordance with example embodiments.

FIG. 9 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein. Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

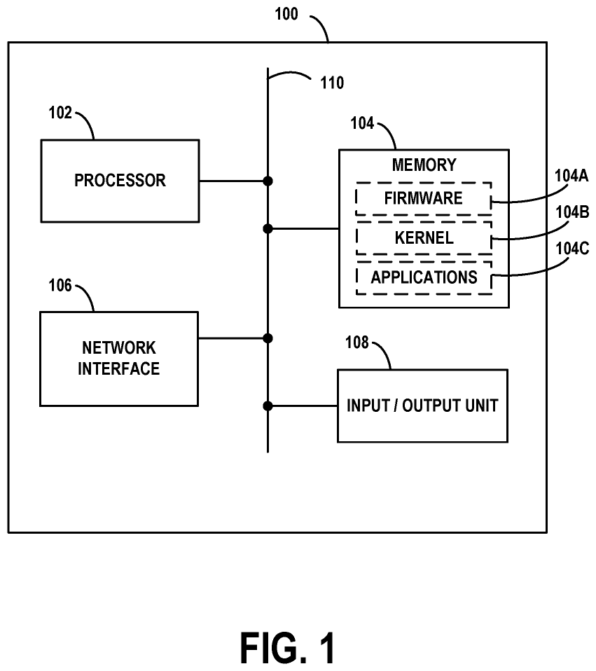

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

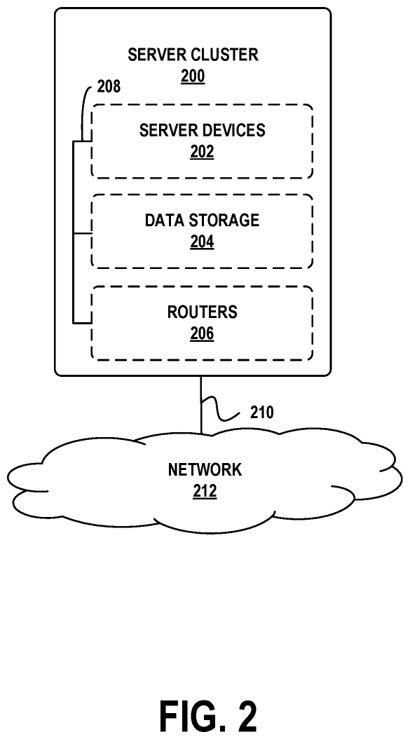

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, the extensible Markup Language (XML), or some other standardized or proprietary format. Moreover, server devices 202 may have the capability of executing various types of computerized scripting languages, such as but not limited to Perl, PYTHON®, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

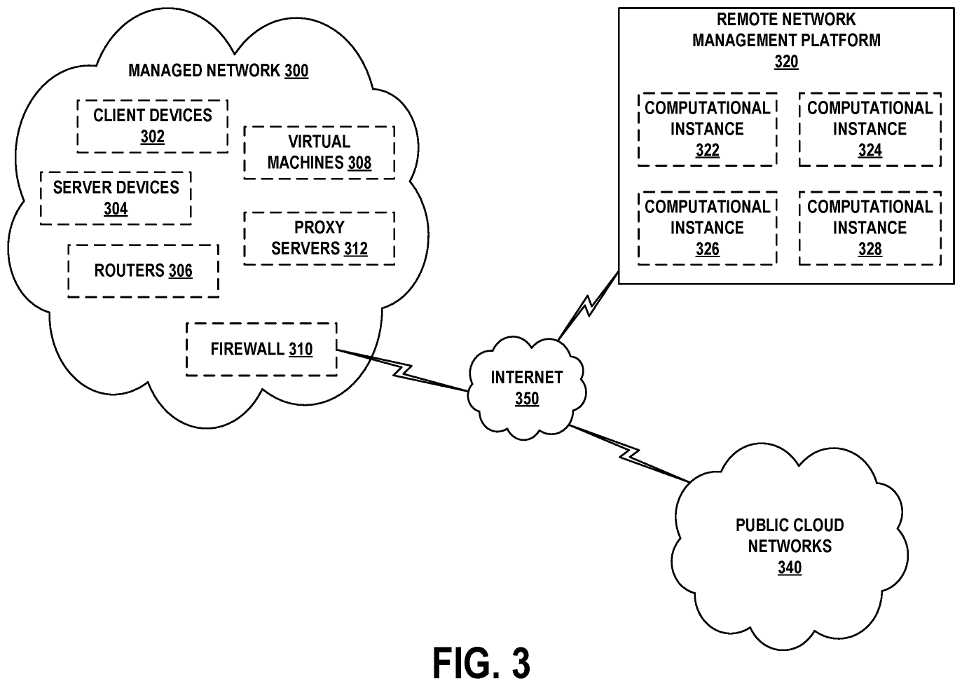

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

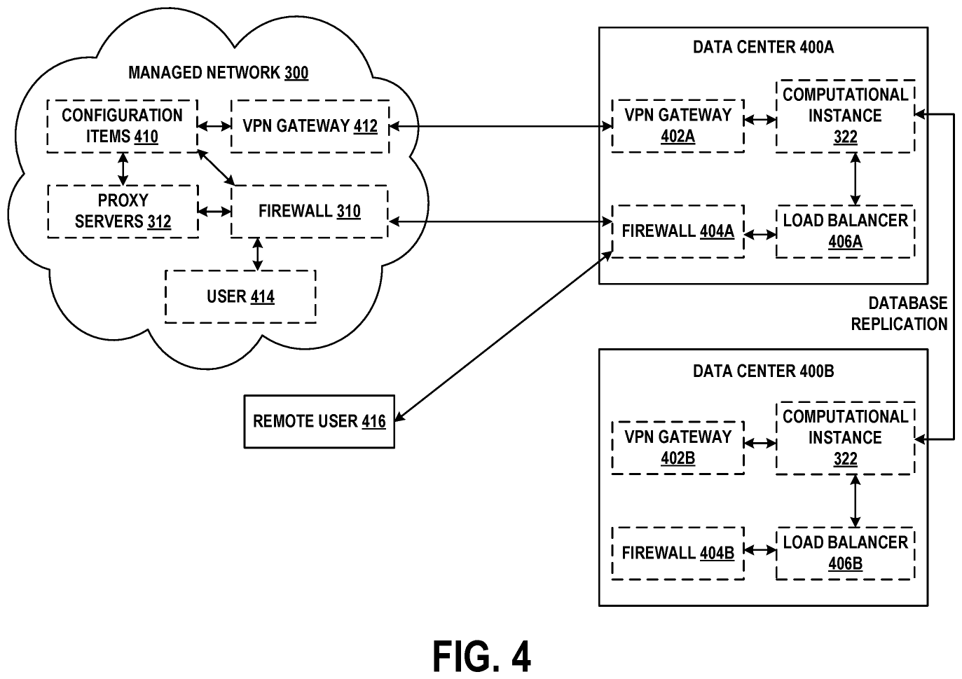

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### IV. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of each device, component, application, and service may be referred to as a configuration item. The process of determining the configuration items and relationships within managed network 300 is referred to as discovery, and may be facilitated at least in part by proxy servers 312. Representations of configuration items and relationships are stored in a CMDB.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

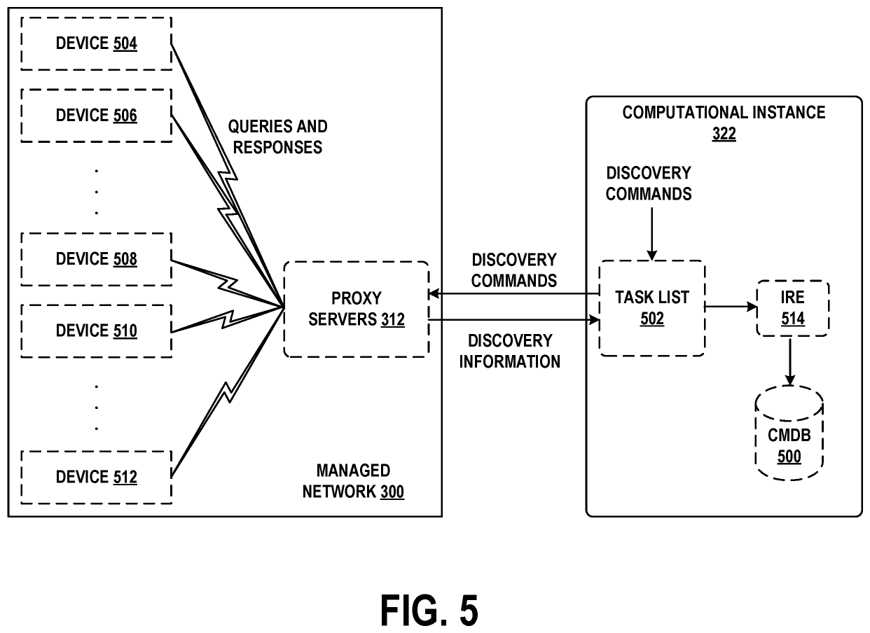

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### V. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VI. Example Platform Applications

Remote network management platform 320 may provide various IT service management (ITSM) solutions including task-based applications designed to streamline and manage specific processes. Three examples of such processes are incident management, case management, and problem management. Each of these examples may benefit from the improvements to clustering model training and prediction described herein. Nonetheless, other types of applications may be present and the embodiments herein apply to these applications as well.

Incident management seeks to provide an efficient resolution of IT service disruptions or incidents. Disruption or incident events can be logged as incidents in an incident management application, which could allow IT teams to track and manage such incidents. Such an application may include features such as incident creation/generation, assignment, prioritization, escalation, communication, and resolution. The incident management application may provide workflows, notifications, and collaboration tools to facilitate the prompt and efficient addressing of incidents, with a goal of minimizing their impact on platform and system operations.

Case management may be designed to handle diverse types of processes, requests, or workflows. Case management can enable users to manage complex cases that require coordination across multiple groups. A case management application may provide a unified platform to capture, track, and manage cases from initiation to resolution. It may include features such as case creation, classification, assignment, task tracking, collaboration, and closure. This application can be tailored to various use cases, such as HR inquiries, legal matters, facilities management, and customer support escalations among others.

Problem management is drawn to identifying and addressing the root causes of recurring incidents or other issues. This can assist IT teams to identify underlying problems that lead to multiple incidents, analyze their impact, and initiate appropriate actions for resolution. A problem management application may provide tools for problem identification, investigation, prioritization, and tracking. It can allow users to link related incidents, perform root cause analysis, define workarounds or solutions, and track the progress of problem resolution. The application helps groups minimize the occurrence and impact of recurring issues, leading to improved service quality and stability for the platform and other systems.

As noted above, other types of applications may be present within or accessible to remote network management platform 320. Incident management, case management, problem management, as well as other applications may be based on dedicated databases that store information related to each incident, case, or problem. This information is typically in textual form (e.g., with words, sentences, paragraphs, or other types of tokens being used to populate various database fields of each entry), but other forms of information (e.g., still images, audio, and/or video) may be included.

Such databases may have different schemas customized for their respective applications (e.g., a unique schema for each of incident management, case management, and problem management). In some scenarios, these databases may cross-reference one another in various ways (e.g., an entry in a problem database relating to a specific problem may refer to one or more entries in an incident database that are deemed to be observations of the specific problem).

In addition, some or all of these applications may have dedicated knowledgebases or may share common knowledgebases. A knowledgebase can include one or more databases of information that centralize and manage an organization's knowledge resources. Example features of a knowledgebase include: content in the form of text articles, search functionality, access control, feedback, integration with task-based applications, and analytics. For example, a knowledgebase can work in conjunction with an incident management application to provide a central repository of articles that can be used to troubleshoot and resolve incidents. These articles can be used for self-service purposes by end users of remote network management platform 320 as well as to aid the support services provided by IT agents who are tasked with assisting end users. Further, a knowledgebase can facilitate information sharing by including documentation of lessons learned and solutions from previous incidents in the form of knowledgebase articles. In some cases, an incident management application can suggest relevant knowledgebase articles that might help in resolving incidents.

These documents can be created, modified, and organized by authorized users within the organization. They act as a repository of knowledge, capturing information on various topics, including troubleshooting guides, FAQs, how-to guides, and best practices. The knowledgebase may support versioning, allowing multiple revisions of an article to be stored. This can help maintain a history of changes, updates, and improvements made to an article over time.

As noted, such knowledgebase articles may be solutions to previous incidents and disruptions. These knowledgebase articles may be linked to the incident or disruption (e.g., by a unique identifier of the incident or disruption and/or a hyperlink to the incident or disruption). The incident or disruption, through its connections with the knowledgebase articles, can form another portion of the knowledgebase. These connections can change over time for reasons including novel features that introduce new or remove certain functionalities. In such a way, an incident or disruption may be linked to one knowledgebase article at one point in time but be linked with another knowledgebase article at another point in time. Similarly, one knowledgebase article may be linked to one incident or disruption at one point in time but be linked to another incident or disruption at another point in time.

The knowledgebase may also be able to restrict access based on user roles and permissions. This can help ensure that sensitive or confidential information is only accessible to authorized personnel.

Also, users may have the option to provide feedback on knowledgebase articles, indicating whether a knowledgebase article was helpful or to what extent the article was or was not helpful. This feedback can help in identifying areas for improvement and maintaining the quality of the knowledge repository. The platform may also record article usage (e.g., views and feedback) and provide reporting and analytics features to track their usage and effectiveness. This could allow administrators to monitor article popularity and usefulness, search trends, and user satisfaction.

A knowledgebase may offer robust search capabilities to help users (e.g., end users or IT agents) find relevant knowledgebase articles. Users may be able to use keywords, terms, phrases, tags, or categories as content of search queries for a knowledgebase. The knowledgebase may provide a list of knowledgebase articles relevant to the content of the search queries. Alternatively, remote network management platform 320 may be configured to automatically search for relevant knowledgebases articles based on keywords, terms, phrases, tags, or categories appearing in incidents, cases, and/or problems. Thus, knowledgebase queries may come from multiple sources (e.g., users or other applications) and may provide results in various ways (e.g., either in a standalone list or integrated with another application). For example, if a search query related to a particular incident is provided to the knowledgebase, a resolution to a similar incident could be used to resolve the particular incident.

To do so, a knowledgebase may employ some form of similarity analysis between the content of a search query and the content of knowledgebase articles. The similarity analysis may determine a similarity metric for each one or more of the knowledgebase articles, where the metrics represent respective degrees of semantic and/or contextual similarity between the search query and the knowledgebase articles. Here, the quality of the search results can be dependent (perhaps heavily dependent) on how the similarity metrics are determined.

Such a similarity metric can be calculated in a number of ways. The discussion below describes how similarity based on clustering can be carried out and the technical advantages thereof. Despite similarity being introduced in the context of the relationships search queries and between knowledgebase articles, similarity calculations can be performed by any of the applications described herein and possibly other applications as well.

### VII. Clustering

Clustering is a form of data analysis in which objects, such as incidents, cases, problems, and knowledgebase articles that share some form of semantic and/or contextual similarity are grouped together and separated from objects that do not share that form of similarity to the same extent. Clustering may involve projecting these objects into n-dimensional representations (e.g., vectors of numbers) that can be compared with one another. Similarity between these representations can be measured in a variety of ways, including Euclidean distance, Manhattan distance, Pearson correlation, cosine similarity, Jaccard distance, and Spearman correlation. Other possibilities exist.

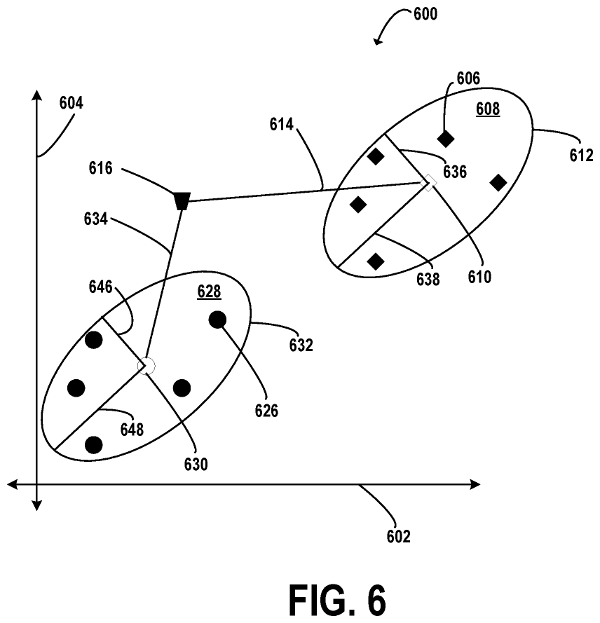

FIG. 6 shows clustering space 600 in accordance with an example embodiment. In FIG. 6, the objects that will be clustered lie in a plane formed along first dimension 602 and second dimension 604. The number of dimensions being two in FIG. 6 is for ease of display and should not be seen as limiting. Clustering can occur for objects that exist in any number of dimensions.

First set of objects 606 (represented in diamond shapes) forms first cluster 608 with first centroid 610. First centroid 610 can be determined based on computations applied to first set of objects 606, such as the arithmetic mean, median, geometric mean, or harmonic mean of first set of objects 606. These computations can be calculated independently for each dimension. For example, if there are three objects in two-dimensional cluster, the x coordinate of the centroid might be the arithmetic mean of the x coordinates of the three objects and the y coordinate of the centroid might be the arithmetic mean of the y coordinates of the three objects. First centroid 610 could be an element of first set of objects 606 or could be distinct from first set of objects 606. For example, first centroid 610 could be the element of first set of objects 606 that is most similar to the result of the computations applied to first set of objects 606, with similarity defined according to any of the previously described ways.

First cluster 608 has first boundary 612. First boundary 612 can be formed based computations applied to first set of objects 606, such as the standard deviation, arithmetic mean, median, geometric mean, convex hull, or harmonic mean. First centroid 610 can be first distance 614 away from unassigned object 616 (represents as a trapezoidal shape). Unassigned object 616, in this rendering, is not a part of first cluster 608.

First centroid 610 may be first minor distance 636 from first boundary 612. First centroid 610 may also be first major distance 638 from first boundary 612. First minor distance 636 and first major distance 638 could correspond to the distances from first centroid 610 to first boundary 612 along either first dimension 602 or second dimension 604. Alternatively, first minor distance 636 could be the semi-minor axis of an ellipse enclosing first set of objects 606, and first major distance 638 could be the semi-major axis of an ellipse enclosing first set of objects 606. In another alternative, first minor distance 636 and first major distance 638 could be both equal to the radius of an n-dimensional sphere (hypersphere) that encloses first set of objects 606. Other methods to define first minor distance 636 and first major distance 638 could be defined.

Second set of objects 626 (represented in circular shapes) forms second cluster 628 with second centroid 630. Second centroid 630 can be calculated based on a computation applied to second set of objects 626, such as the arithmetic mean, median, geometric mean, or harmonic mean of second set of objects 626. Second centroid 630 could be an element of second set of object 626 or could be distinct from second set of objects 626.

Second cluster 628 has second boundary 632. Similar to that of first cluster 608, second boundary 632 can be formed based on computations applied to second set of objects 626, such as the standard deviation, the arithmetic mean, median, geometric mean, the convex hull, or harmonic mean. Second centroid 630 can be second distance 634 from unassigned object 616. Unassigned object 616, in this rendering, is not a part of second cluster 628.

Second centroid 630 may be second minor distance 646 from second boundary 632. Second centroid 630 may also be second major distance 648 from second boundary 632. Second minor distance 646 and second major distance 648 could correspond to the distance from second centroid 630 to second boundary 632 along either first dimension 602 or second dimension 604. Alternatively, second minor distance 646 could be the semi-minor axis of an ellipse enclosing second set of objects 626, and second major distance 648 could be the semi-major axis of an ellipse enclosing second set of objects 626. In another alternative, second minor distance 646 and second major distance 648 could be both equal to the radius of an n-dimensional sphere (hypersphere) that encloses second set of objects 626. Other methods to define second minor distance 646 and second major distance 648 are possible.

The number of clusters being two in FIG. 6 is for ease of display and should not be seen as limiting. The number of clusters can range from a value of one to the number of objects in the plane formed along first dimension 602 and second dimension 604.

Assignment of objects into locations in an n-dimensional space (n-space) can be based on various techniques that can be used to project data into multiple dimensions. For example, keywords, terms, phrases, tags, categories, or other forms of content may be represented as n-dimensional vectors, with the value of each dimension of being based on a sematic or contextual value of the content and/or its relationships with other content. For example, the projection of a keyword into n-space may be based on an established meaning of the keyword and/or the set of words surrounding it in a corpus of training documents. Assignment techniques involving encoders are described below.

If first distance 614 is less than second distance 634, unassigned object 616 could be classified as a part of first set of objects 606 in first cluster 608. If first distance 614 is greater than second distance 634, unassigned object 616 could be classified as a part of second set of objects 626 in second cluster 628. Alternatively, unassigned object 616 may be classified to belong to both first cluster 608 and second cluster 628, or to neither of these clusters (e.g., the object could be deemed an outlier or noise).

For example, the degree to which unassigned object 616 belongs to first cluster 608 could depend on the likelihood of belonging to first cluster 608, computed based upon computations like mean and standard deviation, applied to first set of objects 606 and an assumption about the statistical distribution of first set of objects 606, such as that they obey a Gaussian, Pareto, uniform, Bernoulli, or Poisson distribution. The degree to which unassigned object 616 belongs to first cluster 608 could depend on the ratio of first distance 614 to the sum of first distance 614 and second distance 634. Other methods to calculate the degree to which an object belongs to any cluster are possible. Similar calculations can determine the degree to which unassigned object 616 belongs to second cluster 628.

If unassigned object 616 is determined to be a part of first set of objects 606, first centroid 610 could be recalculated. Likewise, first minor distance 636, first major distance 638, and first boundary 612 could be recalculated. Similarly, if unassigned object 616 is determined to be a part of second set of objects 626, second centroid 630 could be recalculated. Likewise, second minor distance 646, second major distance 648, and second boundary 642 could be recalculated.

### A. K-Means Clustering

K-means clustering is a type of clustering model. At a high level, k-means is a technique to cluster objects through iterative refinement of cluster centroids such as first centroid 610 and second centroid 630 as well as objects assigned to the clusters. For example, turning to the two-dimensional clustering space 600, one way to initialize k-means clustering is by an initial assignment of objects to either first set of objects 606 or second set of objects 626. Next, cluster parameters such as first centroid 610, second centroid 630, first boundary 612, and second boundary 632 are calculated based upon operations applied to first set of objects 606 and second set of objects 626. Then, some or all objects are reassigned to clusters based upon the same procedure described above for unassigned object 616. Subsequently, the cluster parameters are recalculated based upon the new assignments of first set of objects 606 or second set of objects 626. This process could be repeated until assignment of objects to clusters do not change or any such changes are within a pre-determined tolerance.

Another way to initialize k-means clustering could be by selecting an object as being first centroid 610 and repeating this process for second centroid 620. Then, objects are assigned to be either first set of objects 606 or second set of objects 626 based upon the distance from the objects to first centroid 610 or second centroid 630. It is possible to initialize k-means clustering multiple times and record metrics measuring the quality of the assignment of the objects to clusters. It is possible to, then, determine a preferred assignment of first set of objects 606 and second set of objects 626 based upon a preferred value of the metrics. It is also possible to apply both initialization approaches. It is additionally possible to apply either initialization approach multiple times using a grid search approach, such as by allowing each of the objects to be first centroid 610 or second centroid 630 across multiple initializations. Other initialization techniques are possible.

These examples and explanations are for the purposes of description. As noted, there can be more than two clusters and the clusters can exist in more than two dimensions. Further, there can be numerous alternative ways to perform k-means clustering.

There are multiple advantages of k-means clustering. K-means clustering does not make assumptions about the statistical distribution of the objects, which can be a strong assumption and hurt the performance of methods when the locations of the objects do not fit the assumed statistical distribution. In addition, the performance of clustering models can be affected significantly by the selection of parameters, especially when the distribution of the objects does not match the distribution assumed through the selection of the parameters. K-means clustering typically has fewer parameters to select compared with other clustering models, which increases its efficacy. Further, in the context of applying clustering models to knowledgebase articles or entries in an incident management, case management, or problem management database, a deviation between the assumed distribution and the actual distribution of the objects could result in dissimilar knowledgebase articles being assigned to the same cluster or similar knowledgebase articles being assigned to different clusters. Such improperly formed clusters could reduce the use of such clusters. For example, improperly formed clusters of entries in an incident management system could give contradictory information regarding the resolution of an incident or disruption.

Other clustering models are possible including Gaussian mixture modelling, density-based spatial clustering of applications with noise (DBSCAN), and ordering points to identify the clustering structure (OPTICS). These approaches follow the same general outline for clustering models but each has a different modification.

In Gaussian mixture modelling, first set of objects 606 and second set of objects 626 are assumed to be drawn from multi-dimensional Gaussian distributions and the parameters of these distributions are estimated iteratively. This technique has strong performance if the distribution of the locations of the objects can be adequately modeled as a combination of multi-dimensional Gaussians. It is possible to model the locations of the objects as a combination of other types of distributions as well beyond a Gaussian distribution. Such distributions include Pareto, uniform, Bernoulli, or Poisson distributions. It is possible to model the locations of the objects as combinations of multiple types of distributions simultaneously.

In DBSCAN, unassigned object 616 can be classified as either a part of first set of objects 606, second set of objects 626, or noise. If unassigned object 616 is greater than a threshold distance away from first set of objects 606 and second set of objects 626, unassigned object 616 is classified as noise. An advantage of such an approach is that DBSCAN could be less affected by noisy data and outliers. OPTICS removes the condition of selecting a threshold.

The embodiments herein may be employed with any of these or other clustering techniques. Nonetheless, k-means clustering is the focus of the discussion below for purposes of illustrating concrete examples.

### B. Text-Based Clustering

First set of objects 606, unassigned object 616, and second set of objects 626 may be text objects. These text objects could be elements of a knowledgebase such as some or all of a knowledgebase article or some or all of an entry in an incident management, case management, or problem management database. An encoder can provide the basis for clustering of such text objects. Encoders or embedders, including One Hot Encoding, term frequency inverse document frequency (TF-IDF), Word2Vec, and Google Universal Sentence Encode (GUSE), take, as input, a text object and produce, as output, a vector of numbers.

As an example, consider One Hot Encoding. For each text object, a vector is formed whose length is the number of unique words in a group of text objects, where each text object may be an article in a knowledgebase or an entry in an incident management, case management, or problem management database. In this vector, each position in the vector corresponds to a unique word. For a particular text object, the value at a particular position in the vector is a “1” if the word corresponding to that position in the vector is in the text object and “0” if the word corresponding to that position in the vector is not in the text object. By applying this procedure to each text object, a group of vectors can be produced. The length of the resulting vectors is equal to the number of unique words across all text objects.

The dimension of vectors produced by an encoding method can be reduced by ignoring words that are uncommon across the text objects and not assigning indices in the vectors for the uncommon words. Shrinking the dimension of the vectors can improve performance and make computations faster. Not shrinking the dimension of the vectors retains information contained in the text object and can result in improved clustering performance, such as similar knowledgebase articles being assigned to the same cluster.

As another example, consider TF-IDF. For a given text object, a vector is created with a length equal to the number of unique words across all text objects. In this vector, each position in the vector corresponds to a unique word. For a particular text object, the value at a particular position in the vector is the product of two numbers. The first number, the term frequency, is the ratio of (1) the number of times that the word corresponding to the particular position in the vector appears in the text object to (2) the total number of words in the text document. The second number is the logarithm of the ratio of the total number of text objects to the number of text objects that contain the word corresponding to the particular position in the vector.

Word2 Vec and GUSE take a different approach as both determine the entries of the vector corresponding to a text document by applying a neural network to the text object. Other possibilities exist.

### VIII. Training and Prediction Framework

Like many machine learning models, clustering models may have distinct training and prediction phases. In the context of clustering models, the training phase may involve determining parameters of such clustering models so that similar objects are grouped together in some fashion. Examples were given above for k-means and text-based clustering. The parameters of a trained clustering model are referred to herein as “artifacts” and are described in more detail below. The properties of certain programming languages may be useful for the training phase. For example, a programming language may be popular and, thereby, could be used to develop novel machine learning methods. The use of such a programming language could facilitate the rapid adoption and comparison of recently developed machine learning methods without the need to translate such methods between programming languages. Further, certain programming languages may be have toolboxes, libraries, or packages that are written such that they do not require interpreters, thereby, increase their computational efficiency.

As an example, the PYTHON® programming language has a well-developed and optimized set of libraries that support the training of machine learning models, such as clustering models. But other programming languages can be used for training.

Once trained, a clustering model can be represented by artifacts and used to execute the prediction phase. During prediction, new objects could be classified based on the clustering model, and thereby, into zero or more of the clusters defined by the artifacts. The properties of certain programming languages may be useful for the prediction phase. For example, a programming language could enable the use of multiprocessing. In multiprocessing, multiple computational tasks are run in parallel across more than one processor at the same time. This can reduce the computational time required to obtain a prediction result and increase computational efficiency. Other programming languages are desirable for the prediction phase when the prediction is being carried out as part of a computational platform that already has support (e.g., in terms of libraries, allocated resources, and programmer expertise) for such a programming language.

As an example, the JAVA® programming language can be used to support the computational infrastructure (e.g., middleware) of remote network management platform 320, thus making it a good candidate for the prediction phase. But other programming languages can be used for prediction.

It is possible that a programming language that has useful characteristics for the training phase may not have useful characteristics for the prediction phase. Similarly, it is possible that a programming language with useful characteristics for the prediction phase may not have useful characteristics for the training phase. For example, a programming language that has packages, toolboxes, or libraries containing novel machine learning methods may not be easily adaptable to the prediction environment. Conversely, a programming language that is well-suited for the prediction phase may not have efficient or sufficient library support for the training phase. Therefore, the use of a single programming language for both the training phase and the prediction phase could reduce computational efficiency during the training phase, the prediction phase, or both.

Assigning the training phase and prediction phase each to different environments can enable the use of a different programming language for the training phase and the prediction phase. This can enable the use of a programming language with useful characteristics for the training phase during the training phase and a different programming language with useful characteristics for the prediction phase during the prediction phase. This can increase computational efficiency and compatibility during both the training phase and the prediction phase.

Moreover, even with a programming language with useful characteristics for the training phase, it can be computationally intensive to train a new clustering model from the beginning each time new training objects are obtained that were not previously present in the training data. Rather than retraining the clustering model, it may more computationally efficient to update an existing clustering model based upon these new objects. Therefore, in some cases, the clusters (and their artifacts as well) may be incrementally updated during the prediction phase (e.g., to increase prediction accuracy and/or efficacy) based on new training data.

There are other advantages of separating the training of a clustering model and the making of predictions using the trained clustering model between two environments. For example, the prediction environment using the trained clustering model may not need to load or store the vast majority of the training data, which could enable fewer processing and memory resources to be required by that environment.

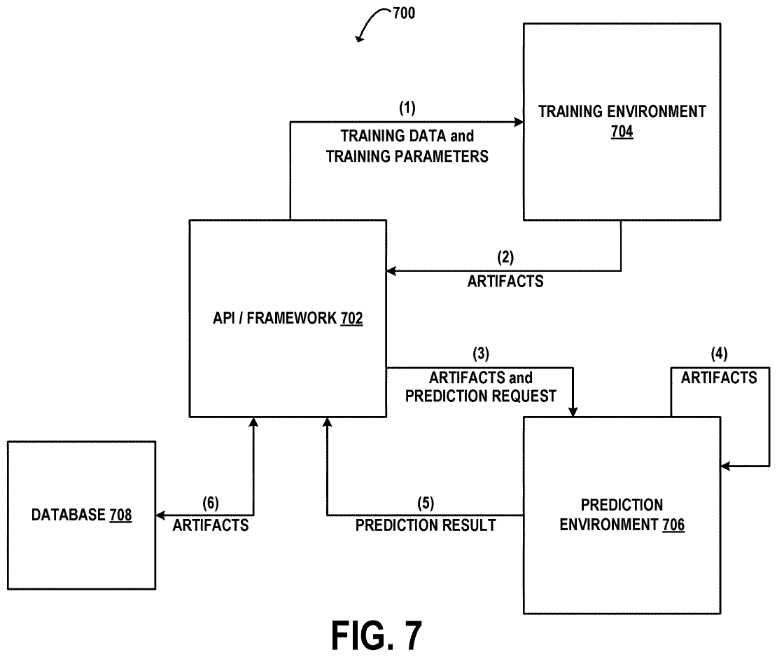

The framework described in FIG. 7 can achieve such a separation between the training phase and the prediction phase. Thus, it can enable a user to benefit from the selection and use of a programming language with favorable characteristics for the training phase during the training phase and a different programming language, with favorable characteristics for the prediction phase, during the prediction phase.

FIG. 7 illustrates training and prediction framework 700 according to an example embodiment. Training and prediction framework 700 comprises API/framework 702, training environment 704, prediction environment 706, and database 708.

API/framework 702 may include a number of APIs and cross-application functionality for use with remote network management platform 320 (to be clear, API/framework 702 may be deployed as an application or set of applications executable on remote network management platform 320). This functionality may include APIs for querying and manipulating database records, writing messages to logs, obtaining user session information, accessing system properties, supporting asynchronous web-based data transfers, client-side scripting, controlling modal user interface windows, and so on. Thus, API/framework 702 may be considered to be middleware and/or a set of support functions.

In a first step, training data could be sent from API/framework 702 to training environment 704. Such training data can be a collection of text objects, such as a collection of knowledge articles incidents, cases, and/or problems, among other possibilities. Training parameters, which define how the clustering model is to be trained, can also be sent from API/framework 702 to training environment 704. The training data could be sent from API/framework 702 to training environment 704 at the same time as the training parameters, or at a different time. This process is depicted with a “(1)” in FIG. 7.

Within training environment 704, a clustering model could be determined based on the training data and the training parameters. Such a clustering model could assign the training data to clusters based on a training algorithm (e.g., k-means training) using the training parameters). Such an assignment can involve the determination or estimation of artifacts.

In a subsequent step, depicted with a “(2)” in FIG. 7, training environment 704 could send artifacts corresponding to the trained clustering model to API/framework 702. API/framework 702 could, then, send the artifacts to prediction environment 706. API/framework 702 could also send a prediction request to prediction environment 706. The prediction request could be a new object for which a clustering assignment is desired. The originator of the prediction request is referred to as the calling application, which may be any application executing on or with access to remote network management platform 320. The prediction request could be sent to prediction environment 706 at the same time as the artifacts or at a later time. This process is denoted with a “(3)” in FIG. 7.

Prediction environment 706 could apply the artifacts to the prediction request to make a prediction result. The prediction result may be an assignment of the new object to zero or more of the clusters defined by the artifacts (e.g., the assigned cluster(s) may be identified by unique number(s) or code(s)). This step is denoted with a “(4)” in FIG. 7.

Then, prediction environment 706 could send this prediction result to API/framework 702. This step is denoted with a “(5)” in FIG. 7. API/framework 702 may return the prediction result to the calling application.

As part of this overall process, API/framework 702 could also send the artifacts to database 708 for storage (e.g., after receiving them from training environment 704). API/framework 702 could further retrieve the artifacts from database 708 (e.g., before sending them to prediction environment 706). This step is denoted with a “(6)” in FIG. 7.

The labeling of the processes in FIG. 7 is for the purpose of description and should not be seen as requiring all such previously described processes from occurring in the same order described above. For example, artifacts could be sent from database 708 to API/framework 702, which could then send the artifacts to prediction environment 706. This could be done, for example, to compare artifacts from different initializations of the clustering model.

### A. Training Parameters

As stated previously, training parameters can also be sent from API/framework 702 to training environment 704. Such training parameters can include the number of clusters, minimum number of objects in a cluster, percentage of objects to classify as outliers, and/or minimum/maximum expected distances. These parameters are using during the training phase to govern or influence the training of the clustering model. Thus, proper selection of these training parameters can improve the utility of the clusters in the trained clustering model.

The number of clusters parameter specifies the total number of clusters into which the objects are placed. A higher number of clusters enables the capture of more nuance and differentiation among objects. However, a lower number of clusters avoids overfitting the data and being affected by outliers or noise in the objects.

The minimum number of objects in a cluster is a threshold and, if the number objects in the cluster is less than the threshold, the objects in the cluster could be classified as noise or reassigned to the clusters with the closest centroids. A small value for the minimum number of objects in a cluster enables the capture of more nuance and differentiation among text objects, which can be informative. However, a large value for the minimum number of objects in the cluster could reduce the introduction of noise as separate clusters. The introduction or worsening of noise in the input to a clustering model can reduce the performance of the clustering model. For example, in the context of applying clustering models to knowledgebase articles or entries in an incident management, case management, or problem management database, the introduction or worsening of noise could result in dissimilar knowledgebase articles being assigned to the same cluster or similar knowledgebase articles being assigned to different clusters. Such improperly formed clusters could reduce the utility of such clusters. For example, improperly formed clusters of entries in an incident management system could give contradictory information regarding the resolution of an incident.

The percentage of objects to classify as outliers is a threshold for the number of objects that can be classified as not belonging to any cluster (e.g., noise). A higher value for the percentage of objects to classify as outliers could reduce the negative effects of noise on the clustering model. However, a lower value of the percentage of these objects could enable better estimation of cluster parameters, such as first centroid 610, second centroid 630, first boundary 612, second boundary 632, first major distance 638, second major distance 648, first minor distance 636, and second minor distance 646. This can be referred to as the coverage or actual coverage and is discussed more in the next section.

The maximum and minimum expected distances can represent multiple types of thresholds. One of these thresholds could be the maximum expected distance between objects and centroids. In this case, if the distance between an object and the object's centroid is greater than the maximum expected distance, the object could be classified as noise or as part of a different cluster.

Another threshold could be the maximum expected distance between objects within a cluster. In this case, if the distance between any two objects within the same cluster is greater than the maximum expected distance between objects within a cluster, the object of those two objects that is further from the cluster's centroid could be classified as noise or as part of a different cluster.

A further type of threshold could be the maximum expected distance between objects across clusters. In this case, if the distance between any pair to objects is greater than the maximum expected distance between objects across clusters, both objects could be classified as noise.

Yet another possible threshold could be the minimum distance between clusters. In this case, if the distances between the centroids of two clusters are less than the minimum distance between clusters, the two clusters could be combined into a single cluster. A further threshold could be the minimum distance between the objects in the same cluster. If the distance between objects within the same cluster is less than the minimum expected distance between objects, one of those two objects could be classified as noise and/or removed from the training data.

A higher value of the maximum expected distance between objects and centroids, a higher value of the maximum expected distance between objects within a cluster, and a lower value of minimum distance between the objects in the same cluster could result in fewer objects classified as noise. This can result in greater statistical power in the computation of cluster parameters, such as first centroid 610, second centroid 630, first boundary 612, second boundary 632, first major distance 638, second major distance 648, first minor distance 636, and second minor distance 646. A lower value of the maximum expected distance between objects or a higher value of the minimum distance between objects allows more objects to be labeled as noise, which can reduce the effects of noise or outliers on the estimation of cluster parameters.

### B. Artifacts

As noted above, artifacts are parameters of a trained clustering model. They can be produced by training a clustering model in training environment 704, for example. While some of these artifacts are useful in the prediction phase (e.g., those describing the size, shape, location and/or unique identifier of each cluster), there may be other artifacts produced that may not be required when making predictions in prediction environment 706 (e.g., the number of training iterations it took for the clustering model to converge and/or the initial values of the parameters prior to training). In other words, training environment 704 may represent a trained clustering model using more artifacts than is needed for that model to be recreated and used in prediction environment 706.

Thus, sending all artifacts associated with a trained clustering model between training environment 704, API/framework 702, prediction environment 706, and/or database 708 could be computationally inefficient because unnecessary information may be transferred between the different environments. This naïve approach uses more memory, computing, and network capacity that is needed.

Nonetheless, there are a number of artifacts that should be copied or moved between training environment 704, API/framework 702, prediction environment 706, and/or database 708. Such artifacts can include object cluster IDs, cluster centroids, cluster distances, cluster assignments, number of clusters, dimension, average number of objects per cluster, cluster distortion, purity, and other clustering information. Nonetheless, other artifacts representing different information can be shared from training environment 704 into API/framework 702, prediction environment 706, and/or database 708.

From these artifacts, a subset can be selected that effectively define the clustering model such that it can be recreated and used in prediction environment 706. This subset might entail, for example, object cluster IDs, cluster centroids, cluster distances, cluster assignments, number of clusters, and dimension. But other subsets are possible for recreating a clustering model in prediction environment 706.

### 1. Object Cluster IDs

Object cluster IDs may be unique identifiers used to identify the clusters. Different clusters could be denoted by unique integer values, for example. A list of cluster IDs can include a further unique identifier for objects that fall outside of clusters, such as outliers and/or noise. Object cluster IDs can be compared across multiple iterations of the clustering model or after inclusion of additional training data to understand how the clusters change with training.

### 2. Cluster Centroids

Cluster centroids may include a list of the centroids of each cluster with indications of their coordinates in n-space and the object cluster ID of the cluster to which they belong. Examples of cluster centroids are first centroid 610 and second centroid 630.

### 3. Cluster Distances

Clusters distance for each cluster may include information about the distances from the centroid of the cluster to that cluster's boundary in n-space, as well as and the object cluster ID of the cluster to which they belong. In general, there may be n cluster distances used to define each cluster, one for each of its dimensions. As noted above, these cluster distances could be measured in multiple ways, such as various mean or median calculations applied to the distances between each object in the cluster and the cluster's centroid. Cluster distances also could be defined using the semi-axes of an n-dimensional ellipsoid. For example, first minor distance 636 and first major distance 638 are cluster distances for first cluster 608, while first minor distance 646 and first major distance 648 are cluster distances for second cluster 628.

### 4. Cluster Assignments

Cluster assignments could include information that identifies the cluster to which each object was assigned. Cluster assignments could include a special categorization for objects classified as noise or outliers. One possible arrangement of cluster assignments is a list of all objects in a table with fields for each object's coordinates in n-space and the object cluster ID of the cluster to which its belongs. Alternatively or additionally, each object could be given a unique identifier and the object cluster ID could be in a table with the unique object identifiers.

### 5. Number of Clusters

The number of clusters can be the number of clusters into which the text objects are clustered. This may be a count of the clusters produced by the clustering algorithm during training of the clustering model.

### 6. Dimension

The dimension may be the size of the vector used to represent the coordinates of the objects (as well as the centroids of the clusters). In other words, in an n-space representation, n is the dimension. This dimension can be provided to and or adjusted by training environment 704, such as through the elimination of minimally informative dimensions. A lower dimension can decrease the amount of time needed to train the clustering model. A higher dimension can result in improved clustering performance. For example, additional dimensions can be used by the trained clustering model to better differentiate between objects with different characteristics.

### 7. Average Number of Objects Per Cluster

The average number of objects per cluster can be the ratio of the total count of clustered objects to the number of clusters. This value represents the density of object assignments to clusters.

### 8. Cluster Distortion

Cluster distortion can measure the internal quality of the clusters formed using the clustering model. For example, clusters containing objects that are not a large distance from the cluster centroid can have low cluster distortion, indicating higher quality, while clusters formed from objects that are a large distance from the cluster centroid can have high cluster distortion, indicating lower quality. Thus, cluster quality scales inversely with cluster distortion.

Cluster distortion could be calculated based upon the sum of the distances between each object within a cluster and the cluster's centroid. Alternatively, cluster distortion could be calculated for each cluster based upon the combination of (1) the sum of the distances between each object within a cluster and the cluster's centroid, and (2) the distances between cluster centroids. Moreover, the sum of the distances of each object not in the cluster to the cluster's centroid could be factor into a measure of the cluster's distortion. There are other ways to combine these values beyond adding them, such as multiplying the values, computing the arithmetic mean of the values, computing the geometric mean of the values, computing the harmonic mean of the values, or doing a weighted sum of the distances.

### 9. Purity

Purity can provide information about the quality of the clusters formed using the clustering model. This can involve a calculation that compares the clusters into which the objects are clustered and an ideal assignment of the same objects. To compute the purity, each object could be assigned to a predefined class. For example, such an assignment of objects to predefined classes could be based upon assignments selected manually by humans, based upon a previously applied clustering model, or based upon the output of a different machine learning method. The number of predefined classes could be the same as or different from the number of clusters.

For a given cluster, the predefined class with the greatest number of objects in that cluster could be the predefined class associated with that cluster. For that same cluster, the number of objects belonging to other predefined classes could be determined. This number could be computed for each cluster and the results added across clusters, yielding the total number of objects assigned to a cluster whose class does not match that object. This number could be divided by the total number of text objects and the resulting fraction could be subtracted from 1. Therefore, a value of purity that is close to 1 could indicate more accuracy in the assignment of classes to clusters, i.e., fewer objects with predetermined classes that conflict with the predetermined class of the cluster to which those objects are assigned. Conversely, a value of purity that is close to 0 could indicate less accuracy in the assignment of classes to clusters, i.e., more objects with predetermined classes that conflict with the predetermined class of the cluster to which those objects are assigned.

### 10. Record Count

Record count can quantify the number of text objects within each cluster. Such values can be compared with the maximum and minimum number of objects in a cluster to determine if the text objects in the cluster should be categorized as noise.

### 11. Other Clustering Information

The artifacts could include other clustering information, including object component weight, coverage, and/or actual coverage. Other possibilities exist. Such information can be used to when updating the clustering model to determine if incorporation of new objects impact clustering performance.

Objects being clustered could contain components beyond just text defining the topic of the object (e.g., the underlying incident, case, problem, knowledgebase article, etc.). This additional information may take the form of metadata. For example, metadata could represent the date of creation of the object, date of modification of the object, urgency of the underlying incident, case, or problem, whether the underlying incident, case, or problem was resolved satisfactorily, and/or time to resolve the underlying incident, case, or problem. This metadata could be used in training the clustering model and could be of a different scale or extent (e.g., number of tokens or words) than the text information. Applying the clustering model without normalizing the scales between the text components and the metadata components could result in the clustering model not appropriately accounting for one or the other.

Thus, text and metadata components could be given different weights. For example, the metadata component of an object could be given a weight of 1, while the text component of the object could be given a weight of 2. The magnitude of these weights could be determined based upon the type of data (e.g., whether the data represents words, numbers, colors, configuration items, user names, countries, etc.) in each component, for example. These weights can be taken into account during training with more training iterations or emphasis placed on items with higher weights.

It could be known that many objects are noise or outliers. Thus, increasing the thresholds that determine whether an object is noise or an outlier until a specified number or percentage of objects are determined to be outliers or noise could increase the utility of the trained clustering model. To this end, coverage may be a threshold for the number of objects that should be placed into clusters. The remaining objects could be noise or outliers. For example, if the coverage is 50%, half of the objects will be used to determine clusters (and therefore cluster parameters). As another example, if the coverage is 95% and both first boundary 612 and second boundary 632 define hyperspheres around first centroid 610 and second centroid 630, the radii of the respective hyperspheres, represented by first minor distance 636 and first major distance 638 and second minor distance 646 and second major distance 648, respectably, could be decreased until 95% of the objects are within first boundary 612 and second boundary 632.

The determination of which objects to not use in the determination of the clusters could be performed in a preprocessing step prior to the application of a clustering model. The actual coverage could be a threshold for the number of objects that should be removed or retained during a preprocessing step. The actual coverage and the coverage could be different. The actual coverage is discussed further in the next section.

### C. Preprocessing

Training data could include objects that are outliers, noise, or with little informational value. Including such objects when training a clustering model could reduce the effectiveness of the resulting clusters or lead to improperly formed clusters. As an example, improperly formed clusters used with an incident management application could provide inconsistent or contradictory information regarding the likely root cause an incident.

Further, in the context of applying clustering models to knowledgebase articles or entries in an incident management, case management, or problem management database, certain locations or dimensions in n-space vectors representing the objects may not provide information that has an appreciable impact on cluster formation. For example, dimensions corresponding to infrequently used words may not influence the formation of clusters. Removing such dimensions prior to training a clustering model may improve computational efficiency because the calculations to train and predict with the clustering model can occur in a lower-dimensional space and therefore on less data.

Another preprocessing approach could take, as an input from API/framework 702, a minimum number of points per cluster and an actual coverage. The preprocessing could begin by computing the pairwise distances between each pair of objects. Then, for each object, the distances between that object and all other objects could be sorted in ascending order. This computation could produce a matrix with a number of rows and columns equal to the number of objects. Next, the distance corresponding to one plus the minimum number of points per cluster could be determined for each object. Then, a percentile of these distances, corresponding to the actual coverage could be determined. In a final step, those objects with distances corresponding to one plus the preprocessing minimum number of points per cluster that are larger than the determined percentile are labeled outliers and not used during training of the clustering model. The value of this percentile could correspond to the actual coverage.

In this approach, the calculation of the pairwise distances for each pair of objects could be approximated using hierarchical navigable small world (HNSW). An advantage of the approximation of collection of the pairwise distances using HNSW could be a reduction in computation time from a computation that is O(N²) to a computation that is O(Nlog(N)), where N is the number of objects. There are other methods by which to determine outliers, including a one-sample Hotelling's T-Square test, random forest, and principal component analysis (PCA).

### IX. Disjoint Training and Prediction Environments

As mentioned previously, certain programing languages could be useful for training environment 704. For example, certain programming languages could have different pre-defined libraries, toolboxes, or packages that support clustering. Further, some programming languages have greater use in different technical fields, be easier to use, or could have improved performance for larger datasets. Moreover, certain programming languages could be expected to become increasingly popular in the future based upon factors like performance and number of current or expected users. In addition, while certain programming languages could be more useful in some aspects, practical considerations, such as the overhead and/or computational complexity of updating an entire system from one programming language to another, could prevent the adoption of a programming language in a particular use case, while enabling the use of the same programming language for a different use case.

PYTHON® could be used as the programming language for training environment 704. One advantage of doing so could be PYTHON®'s cutting edge clustering and machine learning libraries. This can enable novel clustering approaches to be applied to a new problem without the need to convert these approaches to a new programing language. This can improve the speed in which a preferable clustering approach can be determined for a particular problem because there would be no need to convert a novel clustering approach to a new programing language, thereby allowing multiple clustering approaches to be applied to a particular problem more quickly. Moreover, PYTHON® has libraries, written in more efficient, non-interpreter programming languages like C and Fortran, which can reduce computational resource usage. It is possible to use other programming languages for training environment 704.

Certain programming languages could be useful for prediction environment 706. For example, the use of JAVA® as the programming language of prediction environment 706 could enable prediction environment 706 to benefit from improved computational efficiency associated with JAVA® such as multiprocessing. In multiprocessing, multiple computational tasks are run in parallel across more than one CPU at the same time. This can reduce the computational time required to obtain a prediction result. Furthermore, to the extent that JAVA® modules and libraries are already used by remote network management platform 320, the integration of JAVA®-based prediction will be simpler and faster to implement, and easier to debug.

Using the same language for training environment 704 and prediction environment 706 could require compromising computational efficiency and/or compatibility in training environment 704 or prediction environment 706. This is because a single programming language may not have properties useful for both training a clustering model and prediction using the trained clustering model.

In experiments run using PYTHON® as the programing language of training environment 704, using JAVAR as the programming language of prediction environment 706, and HNSW preprocessing, it has been observed that the time spent training the clustering model was decreased by approximately 70% compared with the time spent when JAVA® was used in both training environment 704 and prediction environment 706 and there was no HNSW preprocessing. Further discussion about these experiments is provided in the next section. Nonetheless, it is possible to use other programming languages for training environment 704 and prediction environment 706.

### A. Framework Neutral Approach

Clustering models created in one programming language may not be immediately compatible with another programming language. One solution to this issue can be to convert the clustering model from one programming language to another. For example, if PYTHON® is the programing language of training environment 704 and JAVAR is the programming language of prediction environment 706, the Waikato Environment for Knowledge Analysis (Weka) library in JAVA® could be used to convert the clustering model from PYTHON® to JAVA®.

Another solution can be to save the clustering model in a format that both the first programming language and the second programming language can read or understand. For example, if PYTHON® is the programing language of training environment 704 and JAVA® is the programming language of prediction environment 706, the clustering model can be saved in a JavaScript Object Notation (JSON) format, which may be readable by both PYTHON® and JAVA®. Other language-neutral structured formats like XML could be used as well.

As stated previously, there could be artifacts of a trained clustering model that may be required for training, but may not be used to make predictions with the clustering model. Thus, sending such artifacts from training environment 704 to prediction environment 706 could increase the bandwidth and/or the time required to transfer the trained clustering model from training environment 704 to API/framework 702 and from API/framework 702 to prediction environment 706.

In experiments run using PYTHON® as the programing language of training environment 704 and using JAVAR as the programming language of prediction environment 706, it has been observed that size of the model information sent from training environment 704 to API/framework 702 was reduced by approximately 14 times (over 90%), when sending only artifacts necessary for prediction in a JSON format compared with the model saved in a Weka format.

### B. Updating the Clustering Model

Completely retraining a clustering model can be a time and resource intensive process. Therefore, it may be of interest to minimize the number of times a clustering model is trained from scratch. Instead, it can be more computationally efficient to update an existing clustering model based upon new objects.

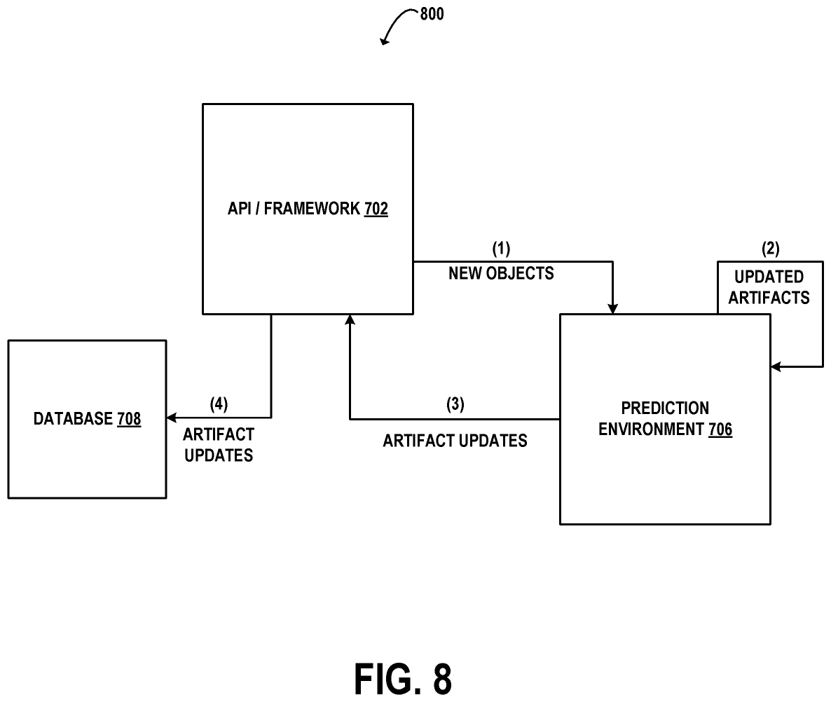

An example configuration for such a framework can be seen in update framework 800 of FIG. 8. Update framework 800 comprises API/framework 702, prediction environment 706, and database 708. Denoted using a “(1)” in FIG. 8, new objects can be sent from API/framework 702 to prediction environment 706. The new objects can be in the same format as or a different format from the training data.

Denoted using a “(2)” in FIG. 8, prediction environment 706 can use the new objects and the existing artifacts to compute artifact updates (described in more detail below). Artifact updates can be any of the previously described artifacts. These updates constitute a change to the trained clustering model.

Denoted using a “(3)” in FIG. 8, prediction environment 706 can send artifact updates to API/framework 702. Artifact updates can be changes to artifacts based upon updating the clustering model to account for new data. Denoted using a “(4)” in FIG. 8, API/framework 702 can send artifact updates to database 708.

The labeling of the processes in FIG. 8 is for the purpose of description and should not be seen as requiring all such previously described processes from occurring in the same order described above. For example, artifact updates could be sent from database 708 to API/framework 702, which could then send the artifact updates to prediction environment 706. This could be done, for example, to compare artifacts from different initializations of the clustering model.

In another embodiment, API/framework 702 can send new objects to training environment 704. Then, training environment 704 can calculate and send artifact updates to API/framework 702. API/framework 702, then, can send the artifact updates to prediction environment 706. Here, the artifact updates could be new values of artifacts or could be instructions, such as mathematical formulas or algorithms, to update the artifacts in prediction environment 706 and database 708. Prediction environment 706 and database 708 could perform these instructions to obtain an updated clustering model.

### C. Artifact Updates

A number of existing artifacts could be used to help update the clustering model. For example, the average number of objects per cluster can be used to determine when to add new clusters to the clustering model or when to rearrange objects amongst clusters. As another example, the number of new clusters can be calculated as the ratio of number of new objects to the average number of objects per cluster. In another embodiment, if any of new objects are beyond cluster percentile distance from all of the centroids, at least some of these objects could be formed into one or more new clusters or labeled as outliers or noise.

The process of updating the artifacts could be repeated multiple times to update the clustering model without any need for retraining the entire clustering model from the beginning. In this way, multiple sets of artifacts, each corresponding to a different version of the clustering model could be obtained. To distinguish these sets of artifacts, they could be referred to as “first artifacts,” “second artifacts,” and “third artifacts,” etc. Each set of artifacts represents a different version of the trained clustering model, and one or more of such models may be administratively selected for use in prediction environment 706.

### X. Example Technical Improvements

These embodiments provide a technical solution to a technical problem. One technical problem being solved is the time and computational resources required to train and update a k-means clustering model and use that updated k-means clustering model to make a prediction. In the context of determining the similarity between objects, such as incidents, cases, problems, and knowledgebase articles, this can be problematic because large computation times for the training phase may hinder the integration of new objects into the clustering model.

The embodiments herein can overcome these limitations by separating the training environment from the prediction environment, using a first programming language for the training environment and a second programming language for the prediction environment. Furthermore, this framework need only provide the artifacts from the training environment to the prediction environment that the prediction environment requires for operation.

In this manner, updating the clustering model, for example a k-means clustering model, in the prediction environment based on new objects can be accomplished in a more accurate and robust fashion. This can result in several advantages. First, the decreased computational time can make it more practicable to update the clustering model. Second, the solution enables the training environment to benefit from cutting edge libraries, packages, and toolboxes exclusively available in first programming language as well as development communities exclusive to first language, while retaining performance benefits from using second language in prediction environment. Third, the solution can enable greater scalability to larger datasets, both in terms of training data and new data.

Another technical solution to a technical problem that these embodiments provide is reducing the computational time taken to determine outliers prior to the use of a clustering model. In practice, this can be problematic because a high computational time reduces the speed at which a clustering model can be trained, making it less desirable to repeatedly update the clustering model. This can result in lower performance for a clustering model. The embodiments herein can overcome these limitation by using HNSW rather than calculating all pairwise combinations of distances between points. In this manner, the speed at which outliers can be determined can be increased. This can enable several advantages, including that it could be more practicable to update the k-means clustering model based upon new text objects.

In experiments run on multiple datasets using PYTHON® as the programing language of the training environment, using JAVA® as the programming language of the prediction environment, and HSNW preprocessing, it has been observed that the time spent training the clustering model was reduced by between 68% and 74% compared to using only JAVA® in both the training environment and the prediction environment and no use of HNSW preprocessing. Also observed in these experiments was that the size of the artifacts in the JSON format was 91.8% to 93.7% smaller than the size of the clustering models saved using the Weka format.

Other technical improvements may also flow from these embodiments, and other technical problems may be solved. Thus, this statement of technical improvements is not limiting and instead constitutes examples of advantages that can be realized from the embodiments.

### XI. Example Operations

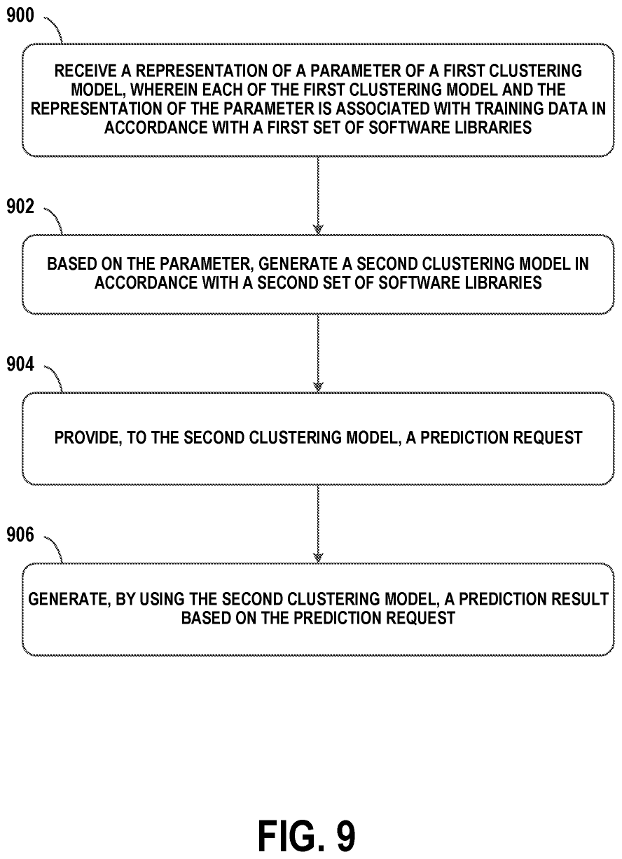

FIG. 9 is a flow chart illustrating an example embodiment. The process illustrated by FIG. 9 may be carried out by a computing device, such as computing device 100, and/or a cluster of computing devices, such as server cluster 200. However, the process can be carried out by other types of devices or device subsystems. For example, the process could be carried out by a computational instance of a remote network management platform 320 or a portable computer, such as a laptop or a tablet device.

The embodiments of FIG. 9 may be simplified by the removal of any one or more of the features shown therein. Further, these embodiments may be combined with features, aspects, and/or implementations of any of the previous figures or otherwise described herein.

A. Receiving a Representation of a Parameter of a First Clustering Model, Wherein Each of the First Clustering Model and the Representation of the Parameter is Associated with Training Data in Accordance with a First Set of Software Libraries

Block 900 may involve receiving a representation of a parameter of a first clustering model. API/framework 702, prediction environment 706, or database 708 could receive the representation of the parameter of the first clustering model. Further, API/framework 702, training environment 704, or database 708 could send the representation of the parameter of the first clustering model. Moreover, the first set of libraries maybe within a first computational environment.

It may be that each of the first clustering model and the representation of the parameter is associated with training data in accordance with a first set of software libraries. The parameter may be one of the training parameters or artifacts described previously, such as cluster centroids, record count, number of clusters. Other values for the parameter are possible.

The training data could be text objects associated with knowledgebase articles or entries in an incident management, case management, or problem management database. Further, the training data could be a collection of knowledge articles, incidents, cases, and/or problems, among other possibilities.

### B. Based on the Parameter, Generating a Second Clustering Model in Accordance With a Second Set of Software Libraries

Block 902 may involve generating, based on the parameter, a second clustering model in accordance with a second set of software libraries. Prediction environment 706 may generate the second clustering model in accordance with the second set of software libraries. The second clustering model may be based on the parameter. The second clustering model may be one of k-means clustering, Gaussian mixture modeling, DBSCAN, or OPTICS, though other clustering models are possible. It is possible for the first clustering model and the second clustering model to be different clustering models. For example, the first clustering model could be based on a k-means clustering model, while the second clustering model could be based on a DBSCAN model. Various combinations of clustering models could be possible. The second set of libraries may be within a second computational environment.

### C. Providing, to the Second Clustering Model, a Prediction Request

Block 904 may involve providing, to the second clustering model, a prediction request. API/framework 702, prediction environment 706, or database 708 could provide the prediction request. The prediction request could be a new object for which a clustering assignment is desired. The prediction request could be sent before, at the same time, or after the parameter.

### D. Generating, by Using the Second Clustering Model, a Prediction Result Based on the Prediction Request

Block 906 may involve generating a prediction result based on the prediction request. It may be that the prediction request is generated by using the second clustering model. Prediction environment 706 could generate, by using the second clustering model, the prediction result based on the prediction request. Prediction environment 706 could send the prediction result to API/framework 702, training environment 704, or database 708.

In some examples, the second clustering model could be operative to make predictions using the parameter.

In some examples, each of the first clustering model and the representation of the parameter could be determined using the training data.

In some examples, each of the first clustering model and the representation of the parameter may be created in a training environment by applying a training algorithm, such as k-means training, to the training data using the first set of software libraries.

In some examples, generating the second clustering model may not involve applying the training algorithm to the training data.

In some examples, the second clustering model may execute in a prediction environment using the second set of software libraries.

In some examples, generating the second clustering model may comprise loading the parameter into the second clustering model.

In some examples, the parameter may define, for a cluster in the first clustering model and in the second clustering model, a centroid of the cluster in an n-dimensional space or a distance from a boundary of the cluster to the centroid in the n-dimensional space.

In some examples, the first set of software libraries could be different from the second set of software libraries.

In some examples, the first clustering model may be based on k-means clustering, Gaussian mixture modeling, DBSCAN, or OPTICS.

In some examples, the parameter could be one of a plurality of parameters of the first clustering model, and the first clustering model could be generated based on determining the plurality of parameters by applying a training algorithm to the training data using the first set of software libraries.

In some examples, it is possible to receive second training data and to update the second clustering model based on the parameter and the second training data in accordance with the second set of software libraries. Further, in some examples, it is possible to provide, to the second clustering model as updated, a second prediction request and generate, by using the second clustering model as updated, a second prediction result based on the second prediction request.

In some examples, updating the second clustering model based on the parameter and the second training data may comprise adjusting sizes of one or more clusters defined by the second clustering model or assignments of objects to the one or more clusters defined by the second clustering model.

In some examples, it is possible to receive a representation of a second parameter of the second clustering model as updated, wherein the second parameter is in accordance with the second set of software libraries. In some examples, it is possible to update the first clustering model based on the second parameter in accordance with the first set of software libraries.

In some examples, the first set of software libraries could be based on a first programming language and the second set of software libraries could be based on a second programming language.

In some examples, the first programming language could be interpreted and dynamically typed, and the second programming language could be compiled and statically typed. The first programming language could be PYTHON® and the second programming language could be JAVA®. Other possibilities are possible.

### XII. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
receiving a representation of a parameter of a first clustering model, wherein each of the first clustering model and the representation of the parameter is associated with training data in accordance with a first set of software libraries;
based on the parameter, generating a second clustering model in accordance with a second set of software libraries;
providing, to the second clustering model, a prediction request; and
generating, by using the second clustering model, a prediction result based on the prediction request.

2. The method of claim 1, wherein the second clustering model is operative to make predictions using the parameter.

3. The method of claim 1, wherein each of the first clustering model and the representation of the parameter is determined using the training data.

4. The method of claim 1, wherein each of the first clustering model and the representation of the parameter was created in a training environment by applying a training algorithm to the training data using the first set of software libraries.

5. The method of claim 4, wherein generating the second clustering model does not involve applying the training algorithm to the training data.

6. The method of claim 1, wherein the second clustering model executes in a prediction environment using the second set of software libraries.

7. The method of claim 1, wherein generating the second clustering model comprises loading the parameter into the second clustering model.

8. The method of claim 1, wherein the parameter defines, for a cluster in the first clustering model and in the second clustering model, a centroid of the cluster in an n-dimensional space or a distance from a boundary of the cluster to the centroid in the n-dimensional space.

9. The method of claim 1, wherein the first set of software libraries is different from the second set of software libraries.

10. The method of claim 1, wherein the first clustering model is based on k-means clustering, Gaussian mixture model clustering, density-based spatial clustering of applications with noise, or ordering points to identify a clustering structure.

11. The method of claim 1, wherein the parameter is one of a plurality of parameters of the first clustering model, and wherein the first clustering model was generated based on determining the plurality of parameters by applying a training algorithm to the training data using the first set of software libraries.

12. The method of claim 1 further comprising:
receiving second training data;
updating the second clustering model based on the parameter and the second training data in accordance with the second set of software libraries;
providing, to the second clustering model as updated, a second prediction request; and
generating, by using the second clustering model as updated, a second prediction result based on the second prediction request.

13. The method of claim 12, wherein updating the second clustering model based on the parameter and the second training data comprises adjusting sizes of one or more clusters defined by the second clustering model or assignments of objects to the one or more clusters defined by the second clustering model.

14. The method of claim 13, further comprising:
receiving a representation of a second parameter of the second clustering model as updated, wherein the second parameter is in accordance with the second set of software libraries; and
updating the first clustering model based on the second parameter in accordance with the first set of software libraries.

15. The method of claim 1, wherein the first set of software libraries is based on a first programming language and the second set of software libraries is based on a second programming language.

16. The method of claim 15, wherein the first programming language is interpreted and dynamically typed, and wherein the second programming language is compiled and statically typed.

17. A non-transitory computer-readable medium, having stored thereon program instructions that, upon execution by a computing system, cause the computing system to perform operations comprising:
receiving a representation of a parameter of a first clustering model, wherein each of the first clustering model and the representation of the parameter is associated with training data in accordance with a first set of software libraries;
based on the parameter, generating a second clustering model in accordance with a second set of software libraries;
providing, to the second clustering model, a prediction request; and
generating, by using the second clustering model, a prediction result based on the prediction request.

18. The non-transitory computer-readable medium of claim 17, wherein the second clustering model is operative to make predictions using the parameter.

19. The non-transitory computer-readable medium of claim 17, wherein each of the first clustering model and the representation of the parameter is determined using the training data.

20. A system comprising:
one or more processors; and
memory, containing program instructions that, upon execution by the one or more processors, cause the system to perform operations comprising:
receiving a representation of a parameter of a first clustering model, wherein each of the first clustering model and the representation of the parameter is associated with training data in accordance with a first set of software libraries;
based on the parameter, generating a second clustering model in accordance with a second set of software libraries;
providing, to the second clustering model, a prediction request; and
generating, by using the second clustering model, a prediction result based on the prediction request.
